(19) United States
(12) Patent Application Publication
(10) Pub. No.: US 2018/0337436 A1
(43) Pub. Date: Nov. 22, 2018

(54) PHASE SHIFTER

(71) Applicant: ALCATEL-LUCENT SHANGHAI BELL CO., LTD, Shanghai (CN)

(72) Inventors: Aurelien Hilary, Lannion (FR); Jerome Plet, Lannion (FR)

(73) Assignee: Alcatel-Lucent Shanghai Bell Co., Ltd., Shanghai (CN)

(21) Appl. No.: 15/776,924

(22) PCT Filed: Nov. 17, 2016
(86) PCT No.: PCT/IB2016/056931

§ 371 Date: May 17, 2018

(30) Foreign Application Priority Data
Nov. 18, 2015 (EP) 15306829.1

(51) Int. Cl. H01P 1/18; H01P 3/08

(52) U.S. Cl. CPC H01P 1/184; H01P 3/081

(57) ABSTRACT

The phase shifter comprises: a transmission line (SAML1) wherein the inner conductor (IC) has a flat shape, a phase tuning plate (PTP) that can be moved, an insulating substrate (IS), and a ground plane (GP). The ground plane (GP) is a continuous plane. The inner conductor (IC) of the transmission line (SAML1) comprises at least one series of slots (S1) creating a predetermined maximal phase shift. The phase tuning plate (PTP) can be moved for modifying the coupling of the phase tuning plate (PTP) and of the at least one series of slots (S1) so that the phase shift created by the least one slot array is reduced as a function of the position of the phase tuning plate (PTP) with respect to the slot array (S1).

### BACKGROUND OF THE INVENTION

### Field of the invention

The present invention generally relates to a phase shifter that can be used in a base station of a mobile telecommunication network.

Current mobile telecommunication market is mainly driven by multiband antennas. A multi-band antenna is a combination of several sub-antennas respectively radiating in a plurality of frequency bands. Integrating five or six sub-antennas in the same volume as a single band antenna is difficult. This low volume is generally required by the customers to get a low visual impact of the antenna. Reducing even more this volume would be appreciated.

In this context, lots of efforts are done to reduce the dimensions of each part of each sub-antenna, i. e. its radiating platform and its feeding network. The dimensions of a radiating platform are mainly driven by physical rules to let each sub-antenna radiate properly without having too much interactions with the others. The feeding network comprises a phase shifting system. This latter is constituted of several phase shifters. A phase shifter is a radio frequency device that enables to form the radiating beam of an antenna, or to tilt it in a 10° to 15° range, with respect to a vertical plane. For instance, to reach a 10° tilt, a phase shifter must achieve a 60° phase shift at 2.2 GHz for an inter-element spacing of 130 mm, with low losses. The dimensions of the feeding network are essentially determined by the technology chosen regarding the phase shifting system.

### Description of the Prior Art

There are two big families of passive phase shifters:
Dielectric phase shifters.
Mechanical phase shifters.

Dielectric phase shifters are based on a standard transmission line (microstrip or stripline) having its own inherent phase. For instance, in the case of a stripline, to get a phase difference between a first and a second transmission line, having a same length, a dielectric plate is inserted below and above the first transmission line, in order to slow down the signal in this first transmission line. At the output of the first transmission line, the total phase shift is the sum of the inherent phase plus the dielectric additional phase shift. The higher the dielectric constant is, the higher the phase shift is, but losses also increase.

Mechanical phase shifters are generally used to get compact and vertically centred (physically centred in the antenna) phase shifting networks. There are rotating phase shifters wherein a central line, which can be rotated, is reducing mechanical length for one port and increasing it for the associated port. Another principle is the “trombone” phase shifter where a “U” shaped part of a line is slit to increase or reduce the mechanical length of a strip.

For instance, a mechanical phase shifter may comprise:

on a first face of an insulating substrate, a microstrip line structure comprising a stub array constituted of microstrip stubs protruding from a microstrip line;

on a second face of said insulating layer, ground plane comprising a plurality of slots adapted to provide signal phase shift with respect to a signal carried by the stub array microstrip line structure on the first face;

and a movable metal member adapted to provide variable coupling between the signal carried by the stub array microstrip line structure and some slots of the ground plane.

The microstrip stubs are adapted to provide impedance compensation for the plurality of slots. The optimization of the combination of studs and slots for impedance compensation is difficult.

The aim of the invention is to propose a compact phase shifter where the impedance compensation can be more easily achieved.

### SUMMARY OF THE INVENTION

The object of the invention is a phase shifter comprising:

a ground plane that is a continuous plane;

an insulating substrate,

a transmission line wherein an inner conductor has a flat shape, the inner conductor of the transmission line comprising at least one slot array creating a predetermined maximal phase shift,

a phase tuning plate that can be moved for modifying the coupling of the phase tuning plate and of the at least one slot array, so that the phase shift created by the at least one slot array is reduced as a function of the position of the phase tuning plate with respect to the slot array.

According to an embodiment, the phase tuning plate (PTP) can be moved in a direction (D1) parallel to the longitudinal axis of the transmission line (SAML1). According to another embodiment, the phase tuning plate (PTP) can be moved in a direction (D2) orthogonal to the longitudinal axis of the transmission line (SAML2).

According to a first aspect, the inner conductor (IC) of transmission line (SAML1) comprises a series of rectangular slots (51), the longitudinal axis of each slot being orthogonal to the longitudinal axis of the transmission line (SAML1) and each slot being centered on the median axis of the inner conductor (IC) of the transmission line (SAML1).

According to a second aspect, the inner conductor (IC) of transmission line (SAML2) is notched by two series of rectangular slots (S2a, S2b), that are interleaved and staggered, the longitudinal axis of each slot being orthogonal to the longitudinal axis of the transmission line (SAML1), and each slot being offset with respect to the median axis of the transmission line (SAML2).

According to a third aspect, the inner conductor (IC) of transmission line (SAML3) has a constant width and zigzags so as to form two series of rectangular slots (S3a, S3b) that are interleaved and staggered.

According to a fourth aspect, the inner conductor (IC) of transmission line (SAML4) comprises a series of circular slots (S4), each slot being centered on the median axis of the inner conductor (IC) of the transmission line (SAML4). According to a fifth aspect, the inner conductor (IC) of transmission line (SAML5) comprises a series of triangular slots (S5), the summits of the triangular slots being interleaved along the transmission line (SAML5)

Thanks to this structure, it is possible to more easily compensate the impedance because it can be done by optimizing slots only. It has also the advantage of a simpler manufacturing.

Other features and advantages of the present invention will become more apparent from the following detailed description of embodiments of the present invention, when taken in conjunction with the accompanying drawings.

### BRIEF DESCRIPTION OF THE DRAWINGS

In order to illustrate in detail features and advantages of embodiments of the present invention, the following description will be with reference to the accompanying drawings. If possible, like or similar reference numerals designate the same or similar components throughout the figures thereof and description, in which:

FIG. 1 represents an exploded view of a first embodiment of the phase shifter according to the invention.

FIG. 2 represents a view of this first embodiment of the phase shifter according to the invention, when the phase tuning plate is placed for providing a phase shift equal to zero degree.

FIG. 3 represents a view of this first embodiment of the phase shifter according to the invention, when the phase tuning plate is placed for providing a phase shift equal to a desired angle different of zero.

FIGS. 4 and 5 represent another embodiment wherein two series of slots are interleaved and staggered to increase the phase shift.

FIG. 6 represents another embodiment wherein a microstrip line zigzags (with meander) for constituting a slot array comprising two interleaved and staggered series of rectangular slots

FIG. 7 represents another embodiment comprising a slot array constituted by a series of circular slots.

FIG. 8 represents another embodiment comprising a slot array constituted by a series of triangular slots.

### DETAILED DESCRIPTION OF THE PREFERRED EMBODIMENTS

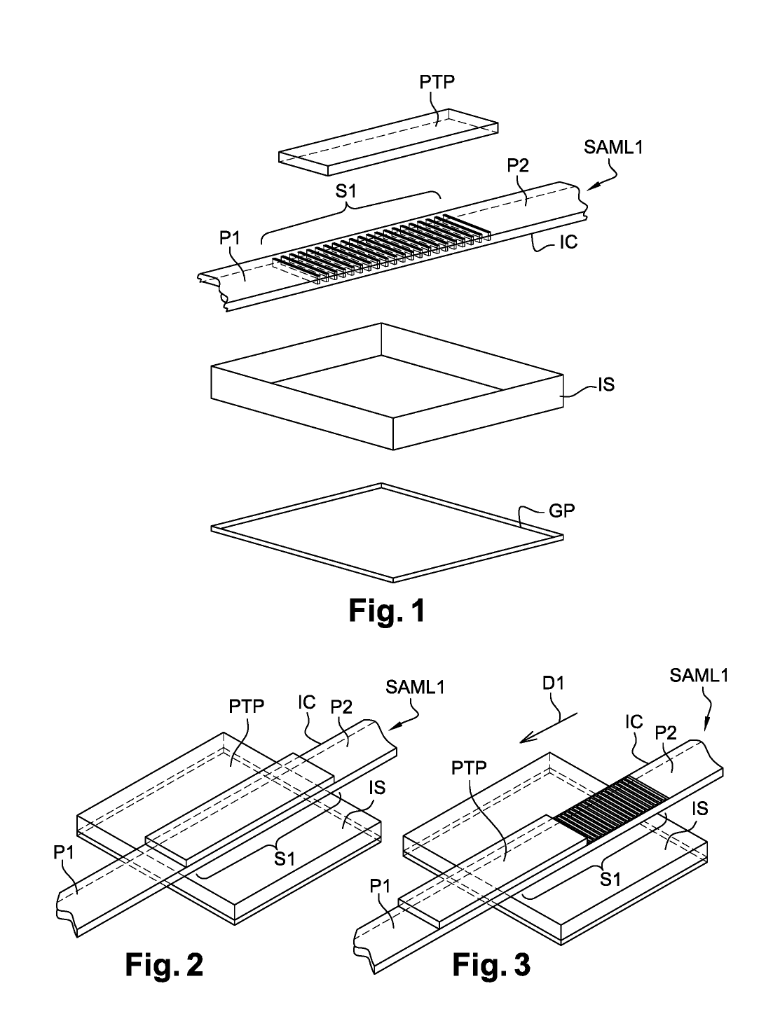

FIG. 1 represents an exploded view of a first embodiment of the phase shifter according to the invention. It comprises:

a conductive phase tuning plate PTP;

a microstrip line SAML1 comprising an inner conductor IC having a flat shape, one end constituting a port P1, a second end constituting a port P2, and this inner conductor IC comprising a slot array constituted by a series of slots S1 perforating the metal of the inner conductor IC;

an insulating substrate IS;

and a continuous ground plane GP.

In other embodiments, the transmission line may comprise a second ground plane, parallel to the ground plane GP, so that the inner conductor IC is in the middle between the two ground planes.

When the first embodiment of the phase shifter is assembled these parts are stacked in this order. The phase tuning plate PTP that can be moved for modifying the coupling of the phase tuning plate PTP and of the series of slots S1 so that the phase shift created by the slot array S1 is reduced as a function of the position of the phase tuning plate PTP with respect to the slot array S1. In this first embodiment, a desired phase shift is obtained by sliding the phase tuning plate PTP preferably along the slot array of the inner conductor IC of the microstrip line SAML1.

In this first embodiment, the slots S1 are narrow rectangular holes; the longitudinal axis of each slot is perpendicular to the longitudinal axis of the inner conductor IC, and each slot being centered on the median axis of the inner conductor IC.

An example of construction of this first embodiment, providing a phase shift of 0 to 10 degrees, at the frequency 2.2 Gigahertz, has the followings characteristics:

The inner conductor IC of the microstrip line is made of copper. Its width is optimized for impedance matching when the phase tuning plate the PTP is out of the slots, and when it is fully covering the slots. In this example, its width is 3 millimeters.

The thickness of the inner conductor IC is 0.035 millimeter (It could be different without effect on the phase shift or the impedance).

The phase tuning plate PTP is made of copper for instance (It could be different), and has the same width as the inner conductor IC (But it is not necessary).

The length of the phase tuning plate PTP is 10 millimeters (But it could be longer). It depends on the frequency band, the slot design, and the desired phase shift.

The insulating substrate IS is made of a dielectric material having a permittivity equal to 2.55 Dk (but it could be different).

The ground plane GP is made of aluminum (but it could be different).

The length of the slot array is 10 millimeters. This is just an example; it needs to be tuned regarding the desired phase shift.

The number of slots is 50 (It depends on the desired phase shift).

The distance between the port P1 and the nearest end of the slot array S1 is preferably greater than the length of the phase tuning plate PTP. So the phase tuning plate PTP can be enough slit for totally uncovering the slot array S1. Then the phase shift is maximal.

The dimensions of the slots may need some slight adjustments to have a good impedance matching. These adjustments are within the scope of a man skilled in the art

The inner conductor IC, the insulating substrate IS, and the ground plane GP constituting the microstrip line SAML1 can be made as a double sided printed circuit.

FIG. 2 represents a view of the first embodiment of the phase shifter according to the invention, when the phase tuning plate PTP is placed for providing a phase shift equal to zero degree: The phase tuning plate PTP is placed on the part of the inner conductor IC that comprises the slot array S1. It completely covers the slot array S1. This latter is shorted; thus the phase shift is zero.

FIG. 3 represents a view of the first embodiment of the phase shifter according to the invention, when the phase tuning plate PTP is placed for providing a phase shift equal to a desired angle, between zero and the maximal phase shift (10° at 2.2 GHz for a 10 mm length slot array in this example). The phase tuning plate PTP has been moved towards the port P1, along the direction D1 parallel to the longitudinal axis of the microstrip line SAML1, so that it only covers a part of the slot array S1. A second part of the slot array S1 is uncovered and creates the desired phase shift.

The phase tuning plate PTP can be moved manually or by an electric actuator. An advantage of the phase shifter according to the invention is its compactness, and its fixed length when varying the phase shift. For instance, as can be seen on FIG. 3, when the phase tuning plate PTP is moved to uncover at least a part of the slot array S1, it is slid along the inner conductor IC of the microstrip line SAML1, towards the port P1. The length of the phase shifter between the ports P1 and P2 is not modified.

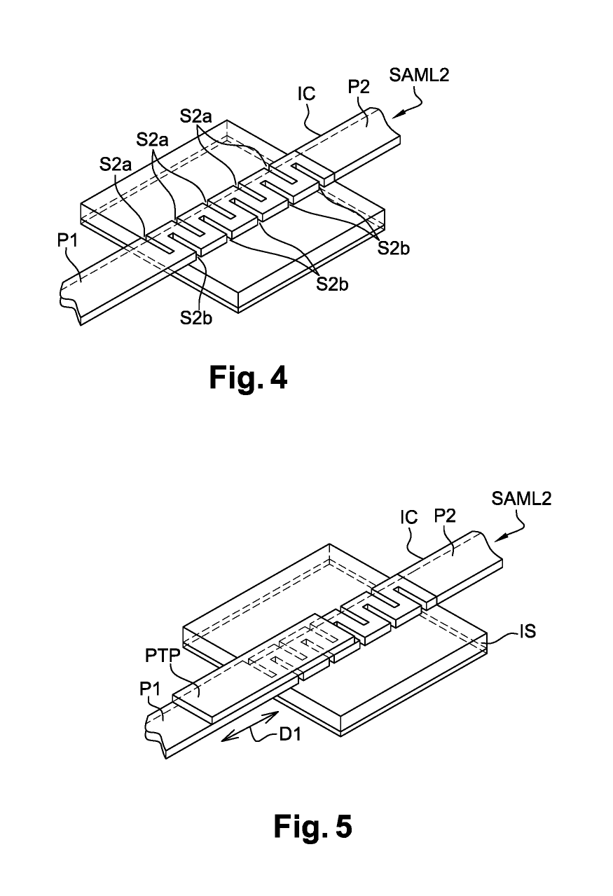

Other designs for the slot array are possible. For example, FIGS. 4 and 5 represent a second embodiment wherein the inner conductor IC of the microstrip SAML2 is notched periodically by two series of slot array, S2a and S2b, which are interleaved and staggered. Each slot is a narrow rectangle with one open side. The longitudinal axis of each slot is perpendicular to the longitudinal axis of the microstrip line SAML2, and each slot is offset with respect to the median axis of the microstrip line SAML2.

This geometry increases the maximal phase shift with respect to the first embodiment. Considering the same length (10 mm), with this design it is possible to obtain a phase of almost 40° at 2.2 GHz compared to 10° for the simple slot array S1 of FIGS. 1 to 3. The widths of the slots may need some slight adjustments to have a good impedance matching. These adjustments are within the scope of a man skilled in the art

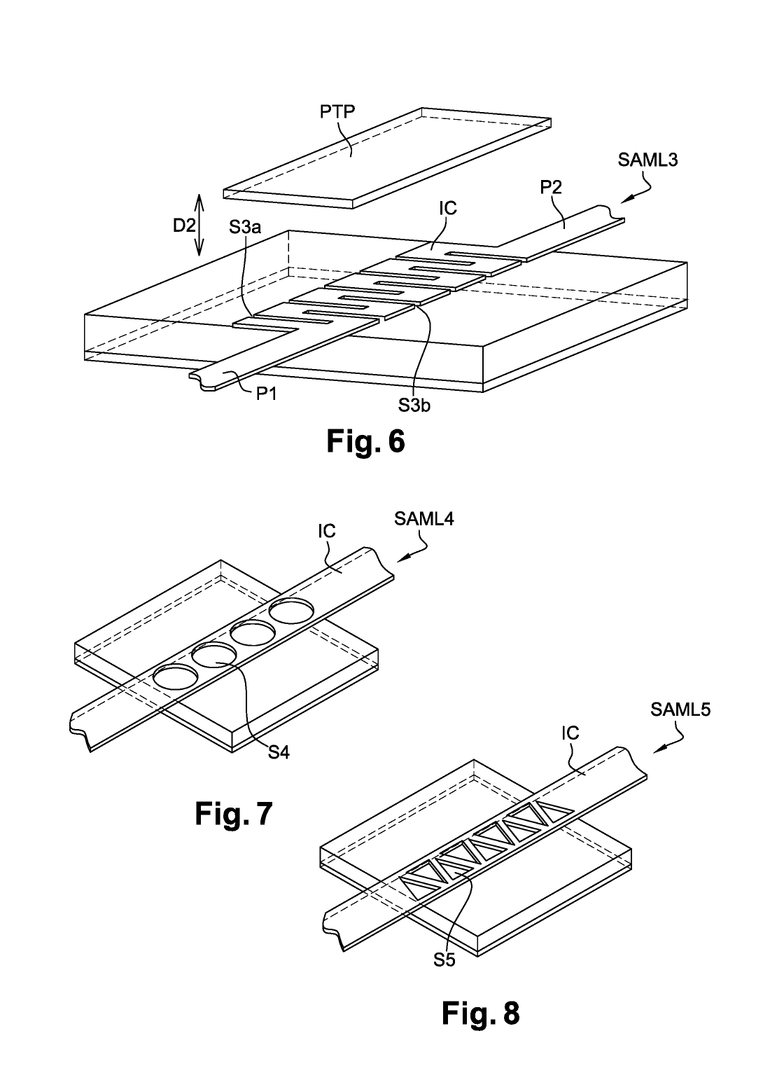

FIG. 6 represents a third embodiment wherein the inner conductor IC of a microstrip line SAML3 has a constant width and zigzags so as to form a slot array comprising two interleaved and staggered series of rectangular slot array S3a and S3b. In this third embodiment, the phase tuning plate PTP can be moved either along a direction D1, sliding in the same way as on FIG. 5, or along a direction D2 that is perpendicular to the plane of the inner conductor IC of the microstrip line SAML3, for modifying the coupling of the phase tuning plate PTP and of the two series of slots S3a, S3b so that the phase shift created by the slot array is reduced as a function of the position of the phase tuning plate PTP with respect to the slot array. The further the phase tuning plate PTP is located with respect to the slot array S3a, S3, the greater the phase shift is, up to a predetermined maximal value.

The phase shifter according to the invention could work while using any slot geometry generating a delay when inserted in the inner conductor of a transmission microstrip line. Then the phase shift can be adjusted either by sliding a phase tuning plate along the slot array, or moving it orthogonally to this slot array in order to modify the delay created by the slot array on the microstrip line.

The shape of each slot can be regular or random. It can mix fractal shapes, coupled lines, etc.

FIG. 7 represents an embodiment comprising a slot array constituted by a series of circular slots S4, the diameters of which are close to the width of the inner conductor IC the microstrip line SAML4. Each circular slot S4 is centered on the median axis of the inner conductor IC of the transmission line SAML4.

FIG. 8 represents an embodiment comprising a slot array constituted by a series of triangular slots S5, the lengths of which are close to the width of inner conductor IC the microstrip line SAML5. The summits of the triangular slots S5 are interleaved along the microstrip line SAML5.

In the above described embodiments, the transmission line is made with the microstrip technology, but the phase shifter according to invention can be made with any technology wherein the inner conductor has a flat shape, in particular the well-known stripline, or suspended stripline, or quasi-stripline technology.

1. A phase shifter comprising
a ground plane,
an insulating substrate (IS),
a transmission line wherein an inner conductor has a flat shape, the inner conductor of the transmission line comprising at least one slot array,
a phase tuning plate configured to move, wherein the position of the phase tuning plate with respect to the at least one slot array is configured to vary the phase shift of the phase shifter.

2. The phase shifter of claim 1, wherein the phase tuning plate can be moved in a direction parallel to the longitudinal axis of the transmission line.

3. The phase shifter of claim 1, wherein the phase tuning plate can be moved in a direction orthogonal to the longitudinal axis of the transmission line.

4. The phase shifter of claim 1, wherein the slot array comprises a series of rectangular slots, the longitudinal axis of each slot being orthogonal to the longitudinal axis of the transmission line and each slot being centered on the median axis of the inner conductor of the transmission line.

5. The phase shifter of claim 1, wherein the slot array comprises a series of rectangular slots, that are interleaved and staggered, the longitudinal axis of each slot being orthogonal to the longitudinal axis of the transmission line, and each slot being offset with respect to the median axis of the transmission line.

6. The phase shifter of claim 1, wherein the inner conductor of the transmission line has a constant width and zigzags.

7. The phase shifter of claim 1, wherein the slot array comprises a series of circular slots, each slot being centered on the median axis of the inner conductor of the transmission line.

8. The phase shifter of claim 1, wherein the slot array comprises a series of triangular slots, the summits of the triangular slots being interleaved along the transmission line.

9. The phase shifter of claim 1 wherein the transmission line, the ground plane and the substrate constitute a microstrip line.

10. The phase shifter of claim 1 further comprising a second ground plane, parallel to the ground plane wherein the inner conductor is between the two ground planes.

11. The phase shifter according to claim 2 wherein the phase tuning plate is configured to slide.
